(19) United States
(12) Patent Application Publication
(10) Pub. No.: US 2026/0072160 A1
(43) Pub. Date: Mar. 12, 2026

(54) VEHICLE SYSTEM AND METHOD FOR OBJECT DETECTION AND AVOIDANCE

(71) Applicant: Spartan Radar, Inc., Los Alamitos, CA (US)

(72) Inventors: Rickey Joe Dawson, Jr., Santa Clarita, CA (US); Neil Mathew Reyes, Laguna Hills, CA (US); Blake Gasca, Rancho Santa Margarita, CA (US); Kevin Jiang, Los Alamitos, CA (US); Huynh Nguyen, Los Alamitos, CA (US); McKinley Souder, Santa Monica, CA (US)

(73) Assignee: Spartan Radar, Inc., Los Alamitos, CA (US)

(21) Appl. No.: 19/320,862

(22) Filed: Sep. 5, 2025

Related U.S. Application Data
(60) Provisional application No. 63/691,478, filed on Sep. 6, 2024.

(51) Int. Cl. G01S 13/86; G01S 7/00; G01S 7/02; G01S 13/931

(52) U.S. Cl. CPC G01S 13/867; G01S 7/003; G01S 7/027; G01S 13/931

(57) ABSTRACT

A system and method for object detection and avoidance are provided. According to some aspects, the method includes providing or installing a vehicle system for object detection and avoidance on a vehicle, the vehicle system comprising at least one detection assembly with a camera unit and a radar unit in communication with the camera unit. The method also includes providing power to the at least one detection module using a network switch connected to the at least one detection module, or providing power to the radar unit using the camera unit in the at least one detection assembly, or both. The method further includes selectively processing data from the camera unit, the radar unit, or both, selectively providing data from the camera unit, the radar unit, or both, to a user interface connected or connectable to the network switch, or both.

This application claims the benefit of priority under to U.S. Provisional Patent Application No. 63/691,478, entitled “VEHICLE SYSTEM AND METHOD FOR OBJECT DETECTION AND AVOIDANCE,” filed on Sep. 6, 2024, the entire disclosure of which is hereby incorporated by reference in its entirety.

This disclosure relates generally to systems and methods for vehicle safety, and more particularly, to systems and methods for object detection and avoidance.

### TECHNICAL FIELD

Radar devices have been incorporated in many vehicles to aid in safe operation and navigation. Generally, a radar device installed in a vehicle can include a transmitter that emits electromagnetic waves and a receiver that detects returning waves from surrounding environment. Signals associated with returning waves can then be analyzed to generate information about the environment, such as position and velocity of an object near the vehicle. Environmental information can then be used to support vehicle operation. For example, upon detecting an object near the vehicle, a radar device may provide an alert to a driver to take evasive or remedial action to avoid imminent collision, or to maintain safe operation of the vehicle.

### BACKGROUND

In some scenarios, a radar device may not provide sufficient information about the environment surrounding a vehicle. Hence, some vehicle technologies utilize camera-based approaches to provide a driver with information about the environment. However, integration of radar and camera systems can be expensive, require additional infrastructure or installation, or may suffer from signal interference.

Therefore, there is a need for improved technologies that ensure vehicle safety.

### SUMMARY

According to some implementations of the present disclosure, a vehicle system for object detection and avoidance is provided. The vehicle system includes at least one detection assembly, attached or attachable to a vehicle, comprising a camera unit and a radar unit in communication with the camera unit, and a network switch connected or connectable to the at least one detection module using at least one communication link, the network switch configured to transfer power and data to the at least one detection module using the at least one communication link. The system also includes a user interface connected or connectable to the network switch using the at least one communication link, wherein the camera unit is configured to receive and provide power to the radar unit.

According to some implementations of the present disclosure, a method for object detection and avoidance is provided. The method includes providing or installing a vehicle system for object detection and avoidance on a vehicle, the vehicle system comprising at least one detection assembly with a camera unit and a radar unit in communication with the camera unit. The method also includes providing power to the at least one detection module using a network switch connected to the at least one detection module, or providing power to the radar unit using the camera unit in the at least one detection assembly, or both. The method further includes selectively processing data from the camera unit, the radar unit, or both, selectively providing data from the camera unit, the radar unit, or both, to a user interface connected or connectable to the network switch, or both.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The foregoing and other advantages of the present disclosure will become apparent upon reading the following detailed description and upon reference to the drawings.

FIG. 1 is an illustration of an example vehicle, according to aspects of the present disclosure;

FIG. 2 is a block diagram of an example object detection and avoidance system, according to aspects of the present disclosure;

FIG. 3 a perspective view of an example detection module, according to aspects of the present disclosure;

FIG. 4 is a schematic diagram of an example user interface, according to aspects of the present disclosure;

FIG. 5 is an illustration of an example visual representation of a vehicle, according to aspects of the present disclosure;

FIG. 6A is an illustration of an example output of a user interface, according to aspects of the present disclosure;

FIG. 6B is an illustration of another example output of a user interface, according to aspects of the present disclosure; and

FIG. 7 is a flowchart setting forth steps of a process, according to aspects of the present disclosure.

### DETAILED DESCRIPTION

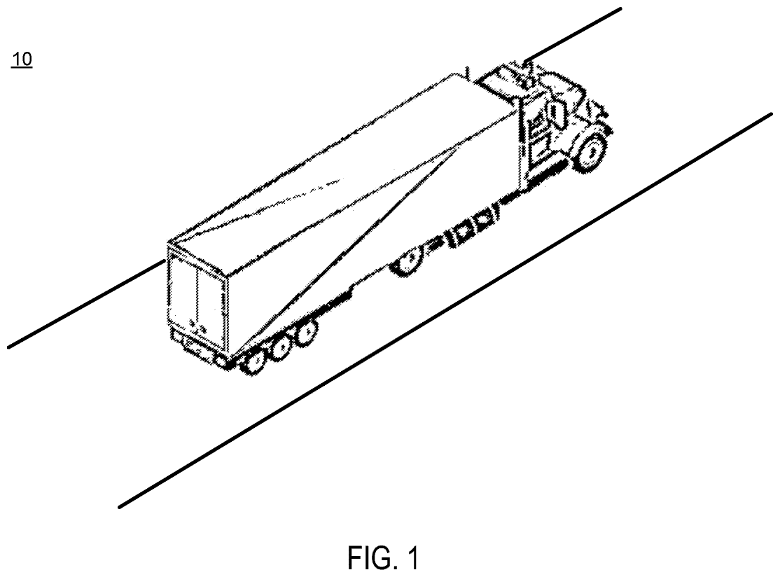

Some vehicles, such as the vehicle 10 illustrated in FIG. 1, can be difficult to operate, and present a risk to drivers and public. Current approaches can be expensive, require additional infrastructure or installation, suffer from signal interference, data limitations, and so forth.

As appreciated from description herein, the present disclosure overcomes these and other deficiencies of previous vehicle technologies. In particular, the present disclosure describes a 360-degree object detection and avoidance solution that provides a number of advantages and improvements in various fields of technology, such as vehicle technologies, and others. For instance, the present approach allows for data integration, enhanced obstacle detection, less intrusive and cost-effective installation, reduced or eliminated data transmission latency, and so on. Accordingly, machine operators, drivers, and driver assist systems can benefit from better visibility and awareness of dynamic environments.

The present disclosure is described with reference to the attached figures, where like reference numerals are used throughout the figures to designate similar or equivalent elements. The figures are not drawn to scale, and are provided merely for illustration. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details, or with other methods. In other instances, well-known structures or operations are not shown in detail to avoid obscuring the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

While the present disclosure is susceptible to various modifications and alternative forms, specific implementations have been shown by way of example in the drawings and will be described in further detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

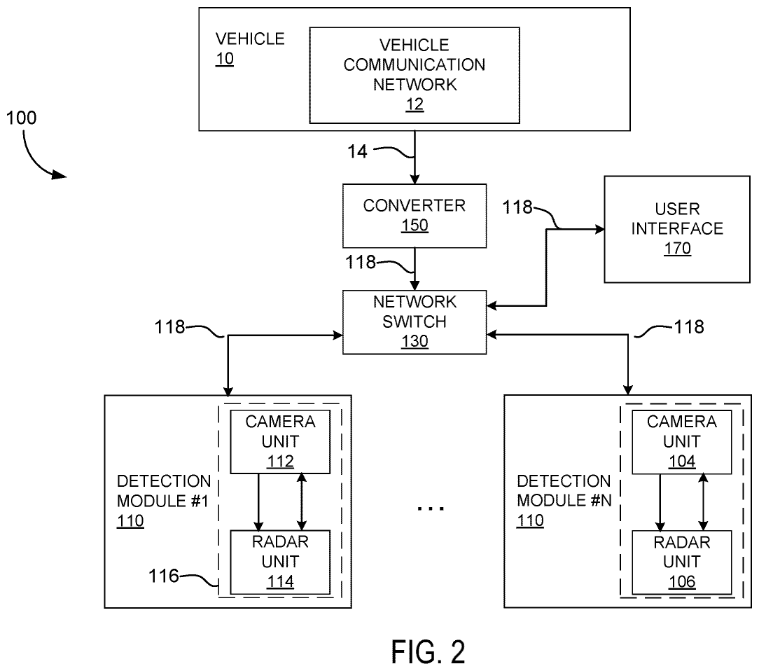

Referring particularly to FIG. 2, a system 100, in accordance with aspects of the present disclosure, is illustrated. As shown, the system 100 may be connected, or connectable, to a vehicle 10, for instance, by virtue of a vehicle communication network 12 and vehicle cable 14. In some embodiments, the vehicle communication network 12 include a controller area network (CAN) bus network, the vehicle cable 14 includes a CAN bus cable (e.g., J1939, PGN 65256, 61445, 65089, and so forth). In general, the vehicle 10 could be any wheeled, powered, manual, autonomous, and/or semi-autonomous vehicle, and utilized for various tasks, such as transportation or movement of people, goods, construction, and so forth. For example, the vehicle 10 may include a car, truck, motorcycle, bus, aircraft, ship, and so forth.

The system 100 may generally include one or more detection module 110, each including a camera unit 112 and a radar unit 114. The camera unit 112 may include one or more camera capable of acquiring imaging within a field of view (FOV). In some embodiments, the camera(s) may support up to approximately 160-degree FOV, although other FOV capabilities may be possible.

The radar unit 114 may include one or more radar sensor, each configured to emit and detect radio frequency signals, for example, in a frequency range between approximately 30 MHz and 300 MHz, although other frequencies may be possible. In some embodiments, the radar sensor(s) may support up to approximately 160-degree FOV, although other FOV capabilities may be possible.

In some configurations, the system 100 may include a plurality of detection module 110 arranged about the vehicle 10 sufficient to cover a 360-degree visual and/or radio perimeter about the vehicle 10. In this manner, blind spots about the vehicle 10 can be avoided, and safety can be enhanced.

In some embodiments, the camera unit 112 and radar unit 114 may be connected, or connectable, to transmit power and data/signals therebetween. To this end, the camera unit 112, the radar unit 114, or both, may include various components, circuitry, transmitters, receivers, and/or hardware for receiving and/or transmitting power, data, and signals. In some implementations, the camera unit 112, the radar unit 114, or both, may be configured to receive and/or transmit power, for instance, between approximately 1 Volt and approximately 10 Volts, although other power values may be possible, via one or more power conduits. In some implementations, the camera unit 112, the radar unit 114, or both, may be configured to use a CAN communication protocol to receive and/or transmit data and/or signals via one or more CAN communication conduits. In other implementations, the camera unit 112, the radar unit 114, or both, may be configured to use a serial communication protocol (e.g., a universal asynchronous receiver-transmitter communication protocol) to receive and/or transmit data and/or signals via one or more serial communication conduits or serial communication network.

In some embodiments, the camera unit 112 and radar unit 114 of a detection module 110 may be incorporated into or attached to a detection assembly (not shown in FIG. 2). For example, the detection assembly may include a support structure to which the camera unit 112 and radar unit 114 may be attached or attachable. The support structure of have any form, shape, and size. In some embodiments, the detection assembly may include at least one enclosure, attached or attachable to the detection assembly, where at least one enclosure covers the camera unit 112 and/or radar unit 114, in whole or in part, to provide protection against environmental conditions.

As illustrated in FIG. 2, each detection module 110 may optionally include a communication platform 116 connecting the camera unit 112 and the radar unit 114. The communication platform 116 may have any form, and include various components, circuitry, and/or hardware. For example, the communication platform 116 may include a circuit board be attached or attachable to the support structure, the circuit board including include various wiring, circuitry, conduits, transmitters, receivers, and/or hardware that connect and/or facilitate communication between the camera unit 112 and radar unit 114.

In some embodiments, the communication platform 116 facilitates transmission of power between the camera unit 112 and the radar unit 114. In some embodiments, the communication platform 116 alternatively or additionally facilitates transmission of data and/or signals, between the camera unit 112 and the radar unit 114 for instance, using a CAN communication protocol. To this end, the communication platform 116 may include a CAN bus network. In some embodiments, the communication platform 116 alternatively or additionally facilitates transmission of data and/or signals, between the camera unit 112 and the radar unit 114, for instance, using a serial communication protocol. To this end, the communication platform 116 may include a serial communication network.

The detection module(s) 110, and/or various units therein, may be connected, or connectable to a network switch 130, using a communication link 118. The network switch 130 may include various hardware configured to connect one or more device, module, computer, interface, hardware, and so forth, in a network, and manage data transmission in the network (e.g., a vehicle network). In some embodiments, the network switch 130 may be a Power over Ethernet (PoE) network switch configured to allow transmission of power as well as data and/or signals in the network. For example, the network switch 130 may facilitate transmission of power between a vehicle 10, or other source of power on the vehicle 10, and one or more detection module (110). In some embodiments, the communication link 118 includes one or more PoE conduit or Ethernet cable.

In some embodiments, the network switch 130 may be connected, or connectable, to a converter 150 one or more communication link 118, as illustrated in FIG. 2. In some embodiments, the converter 150 may be a CAN bus converter configured to convert CAN data received through the vehicle cable 14 to one or more data types, such as a data type compatible with an Ethernet communication protocol, a serial communication protocol, and so forth. In some implementations, the converter 150 may receive various data from the vehicle 10, such as vehicle operational data of the vehicle 10 (e.g., turn signal activation, gear activation, gear position, vehicle speed, and so forth).

In some embodiments, the converter 150 receives power, for instance, from a battery on the vehicle 12, or from another power source, and transmits power to the network switch 130 using a communication link 118 therebetween. Alternatively, or additionally, the network switch 130 receives power from the battery on the vehicle 12, or from another power source, and transmits power to the detection module(s) 110, and/or various units therein, using a communication link 118 therebetween.

As illustrated in FIG. 2, in some embodiments, the network switch 130 may be connected, or connectable, to a user interface 170. The user interface 170 may include or be part of any device, system, or apparatus. For instance, in some embodiments, the user interface 170 may be part of a vehicle navigation system, vehicle console, head-up display (HUD), and so forth. In other embodiments, the user interface 170 may be a standalone device, personal device, computing device, smartphone, tablet, and so forth. In some embodiments, the user interface 170 may include or integrate with various Android/iOS and other Operating Systems, for instance, as found in vehicle technologies.

In some embodiments, the user interface 170 may be configured to receive various signals/data from one or more detection module 110, and provide various raw and/or processed signals/data to a user, for example, via a display. To this end, the user interface 170 may be configured to analyze or process signals/data received from the detection module(s) 110. In some embodiments, the user interface 170 may be configured to receive vehicle operational data (e.g., turn signal activation, gear activation, gear position, vehicle speed, and so forth) from the vehicle 10, for example, via the vehicle communication network 12.

Responsive to the vehicle operational data received, the user interface 170 may provide various data and signals. For example, the user interface 170 may selectively report or display signals and data from a detection module 110 associated with the vehicle operational data received. For example, responsive to left turn signal being activated on the vehicle 10, signals and data from one or more detection module 110 positioned on a left side of the vehicle 10 may be displayed. To this end, vehicle operational data may trigger selective usage, transfer, analysis, and/or display of detection module 110 data and signals. In this manner, an adaptable three-dimensional (3D) display may be provided to a user. In some implementations, the report may include visual zones and/or segments for various sides of the vehicle 10 (e.g., front, rear, left, right), thereby informing an operator and/or vehicle one any object in proximity to or on a collision path with the vehicle.

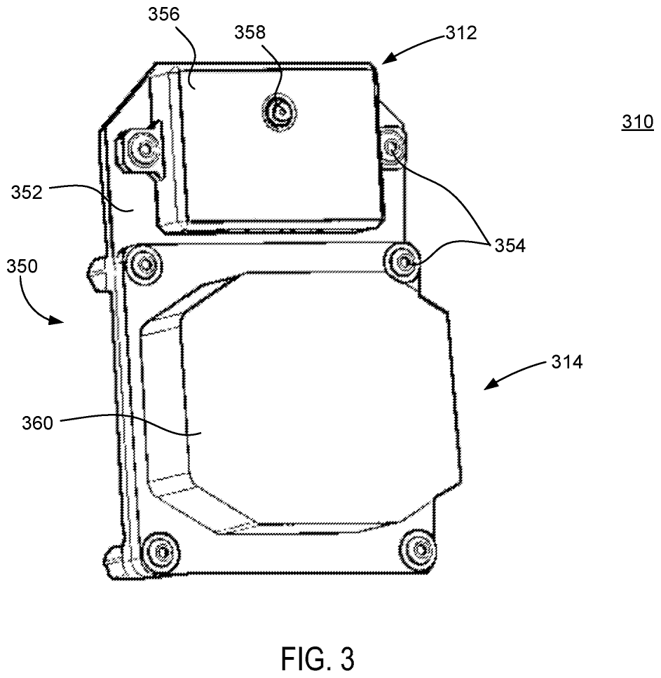

Turning to FIG. 3, an example detection module 310, according to aspects of the present disclosure, is illustrated. In general, the detection module 310 may include a camera unit 312 and a radar unit 314. As illustrated in FIG. 3, the detection module 310 may be incorporated into or attached to a detection assembly 350. In some embodiments, the detection assembly 350 may include a support structure 352 to which the camera unit 312 and radar unit 314 may be attached or attachable by way of a number of fasteners 354. In some embodiments, the detection assembly 350, or various components therein, may include one or more feature and/or component configured to movably position or immovably secure the detection module 310 to a vehicle.

In some embodiments, the support structure 352 may include a communication platform incorporated, attached, or attachable thereto. As described, the communication platform may connect the camera unit 312 and the radar unit 312. The communication platform may have any form, and include various components, circuitry, and/or hardware. For example, the communication platform may include a circuit board be attached or attachable to the support structure 352, the circuit board including include various wiring, circuitry, and/or hardware that connect and/or facilitate communication between the camera unit 312 and radar unit 314. In some embodiments, the communication platform facilitates transmission of power between the camera unit 312 and the radar unit 314. In some embodiments, the communication platform alternatively or additionally facilitates transmission of data and/or signals, between the camera unit 312 and the radar unit 314 for instance, using a CAN communication protocol. To this end, the communication platform may include a CAN bus network.

In some embodiments, the communication platform may be configured to connect to one or more external apparatus, device, system, and so forth. For instance, the communication platform may be configured to engage a connector of a communication link connecting the detection module 310, and/or various units therein, to, for example, a network switch. In some embodiments, the network switch may include a PoE network switch configured to allow transmission of power as well as data and/or signals between the network switch and the detection module 310, and/or various units therein. As such, the communication platform may include one or more receptacle or connector that may receive one or more PoE conduit, Ethernet cable, and so forth.

The detection assembly 350 may also include at least one enclosure securing and/or protecting components therein. For instance, in some embodiments, the camera unit 312 may include a camera enclosure 356 securing and/or protecting a camera 358 therein, as illustrated in FIG. 3. In some embodiments, the radar unit 314 include a radar enclosure 360 securing and/or protecting one or more radar sensor therein (not shown in FIG. 3).

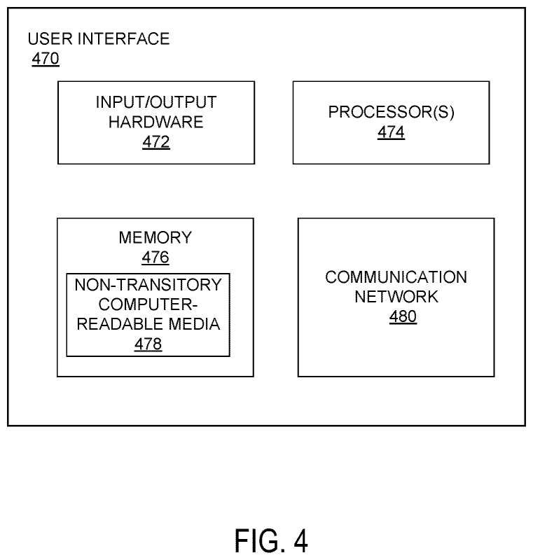

Turning to FIG. 4, an example user interface 470, according to aspects of the present disclosure, is illustrated. In some embodiments, the user interface 470 may include or be part of any device, system, or apparatus, such as vehicle navigation system, vehicle console, head-up display (HUD), and so forth. In other embodiments, the user interface 470 may be a standalone device, personal device, computing device, smartphone, tablet, and so forth.

In some embodiments, the user interface 470 may include various input/output (I/O) hardware 472, one or more processor 474, at least one memory 476, and communication hardware 478, as shown in FIG. 4.

In particular, the I/O hardware 102 may include various input and output elements for receiving and relaying various signals, data and information. Example input elements may include a mouse, keyboard, touchpad, touchscreen, buttons, and other user interfaces configured for receiving various selections, indications, and operational instructions from a user. Example output elements may include displays, touchscreens, speakers, LCDs, LEDs, and so forth. Input and/or output elements may also include various I/O receptacles and ports, such as flash-drive ports, USB ports, CD/DVD drives, network ports, serial ports, audio/video ports, IEEE ports, ethernet ports, and other receptacles for sending and/or receiving various signals, data and information, as well as power.

The processor(s) 474 may be configured to carry out various functions, processing, and operations for the user input interface 470. In some embodiments, the processor 474 may include one or more programmable or dedicated processor configured (e.g., programmed and/or hardwired) to carry out steps in accordance with the present disclosure, for instance, using executable instructions stored in a non-transitory computer-readable medium 478. By way of example, the processor(s) 474 may include one or more central processing unit (CPU), graphics processing unit (GPU), microprocessor, digital signal processor, microcontroller, application specific integrated circuit (ASIC), programmable logic device (PLD), field programmable logic device (FPLD), field programmable gate array (FPGA), and so forth.

In some embodiments, the processor(s) 474 may be configured to receive, via I/O hardware 472, various signals and data from one or more detection module, for instance, as described with reference to FIGS. 2 and 3. The processor(s) 474 may then analyze and/or process received signals and data. In some implementations, the processor(s) 474 may use various algorithms (e.g., computer vision algorithms) to detect one or more objects using imaging data and/or radar data.

Responsive to analysis and/or processing of received signals and data, the processor(s) 474 may provide various raw and/or processed signals, data, and information to a user, for example, in the form of a report. The report may be in any form and include any signals, data, and information. In some implementations, the report may be provided to a user using a display of the I/O hardware 472. In other implementations, the report may be stored locally in a memory, or in another storage location. In yet other implementations, the report may be transmitted to a remote location, remote or cloud device (e.g., computer, mainframe, server, database, etc.), and so forth, using the communication network 480. The report may be provided intermittently and/or continuously. In some implementations, the report may be provided based on a trigger event. For instance, detection of one or more object in proximity to or on a collision path with the vehicle, or another trigger event, as determined by the processor(s) 474, may trigger generation, display and/or transmission of the report to a user interface, remote device, or cloud device.

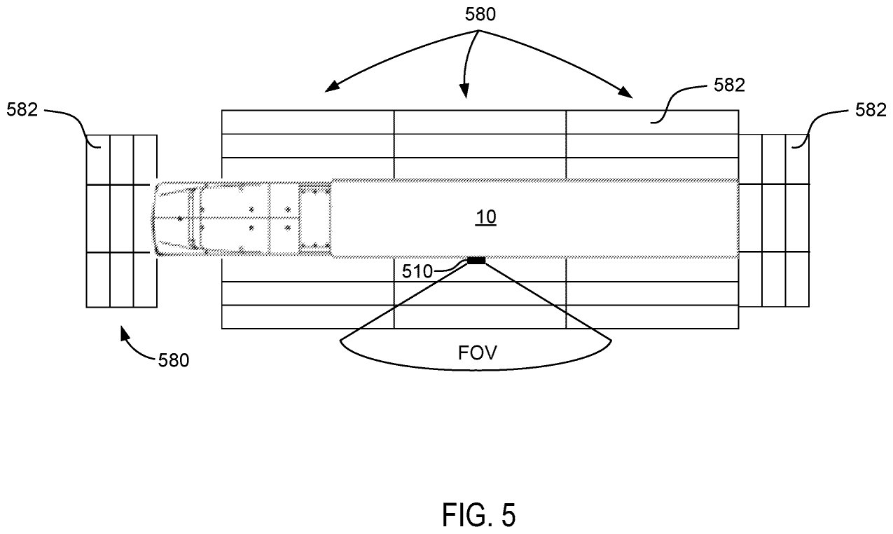

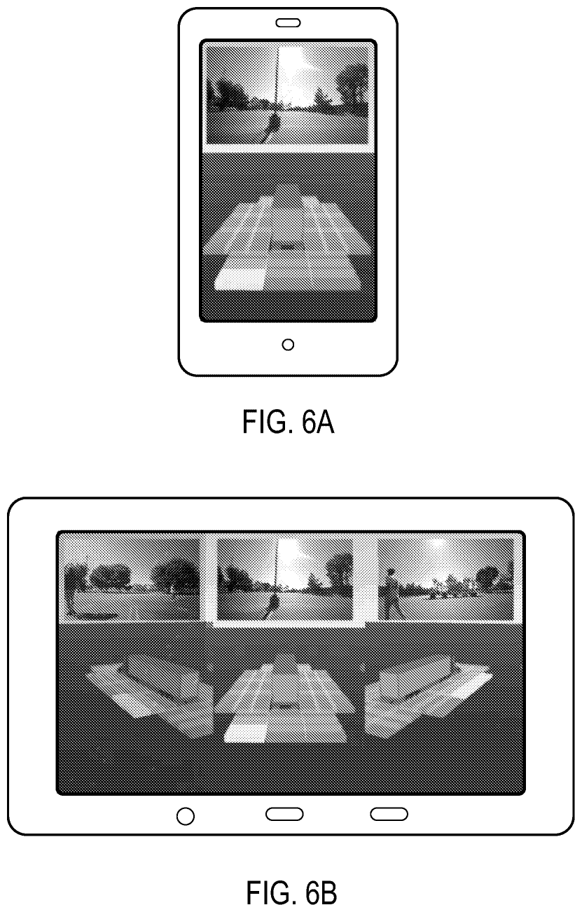

In non-limiting example, the report may include one or more visual representation of a vehicle 10 with one or more vehicle zones 580 and/or segments 582, each corresponding to a side of the vehicle 10 (e.g., front, rear, left, right), as illustrated in FIG. 5. Each vehicle zone 580 may correspond to a FOV of a detection module 510, or of a component therein, positioned on the vehicle 10, as shown. The report may also provide various visual and/or audio indications, such as indications of one or more object detected around a vehicle and/or risk associated with one or more object detected around a vehicle, imaging or real-time video captured by one or more detection module positioned on the vehicle, and so forth. (FIGS. 6A-6B).

Referring again to FIG. 4, in some embodiments, the processor(s) 474 may be configured to receive vehicle operational data (e.g., turn signal activation, gear activation, gear position, vehicle speed, and so forth) from a vehicle. For example, vehicle operation data may be provided by a vehicle 10 through a vehicle communication network 12, as described with reference to FIG. 2. Responsive to the vehicle operational data received, the processor(s) 474 may selectively process and/or provide various data and signals to a user. For instance, in some implementations, the processor(s) 474 may be configured to selectively display raw and/or processed signals and/or data from one or more detection module on a vehicle based on vehicle operational data received. For example, responsive to a left turn signal being activated on the vehicle, the processor(s) 474 may display signals and data from one or more detection module positioned on a left side of the vehicle. In some implementations, the processor(s) 474 may be configured to selectively display raw and/or processed signals and/or data from one or more detection module on a vehicle based on processed signals and/or data. For example, responsive to identification of one or more object in proximity to or on a collision path with the vehicle, the processor(s) 474 may display signals and data from one or more detection module positioned nearest the identified object(s) or from one or more detection module expected to capture a collision. To this end, various data may be used to trigger selective usage, processing, analysis, and/or display of detection module data and signals.

The memory 476 may of the user interface 470 may include one or more memory storage device and/or memory unit. In some embodiments, the memory 476 may include non-transitory computer-readable 478 storing one or more sets of instructions (e.g., software) embodying any one or more of the methodologies or functions described herein. In some embodiments, the memory 478 may include any medium that is capable of storing, encoding, or carrying a set of instructions for execution by a computer or machine and that cause the computer or machine to perform any one or more of the methodologies of the various implementations, or that is capable of storing, encoding, or carrying data structures utilized by or associated with such a set of instructions. By way of example, the memory 478 may include a variety of different types of memory storage devices, such as one or more solid-state memory, optical medium, magnetic medium, random-access memory (RAM), read only memory (ROM), non-volatile (NV) memory, as well as floppy disk, hard disk, CD ROM, DVD ROM, flash, and so forth. The memory 478 may also include other readable medium that may be read from and/or written to by a magnetic, optical, or other reading and/or writing system.

The user interface 470 may also include a communication network 480, as shown in FIG. 4. The communication network 480 may include various hardware, components, and devices capable of initiating and/or carrying wireless and/or wired communication using various communication protocols. Example communication protocols include Bluetooth, Wi-Fi, local area network (“LAN”), wide area network (“WAN”), inter-network, peer-to-peer network (e.g., ad hoc peer to-peer networks), and other protocols. To this end, the communication network 480 may include one or more bus, gateway, bridge, receiver, transmitter, transceiver, antenna, as well as other components, circuitry, and hardware to facilitate communication.

In some implementations, the communication network 480 may be configured to connect to a switch, such as the network switch 130 as described with reference to FIG. 2, and receive data/signals and/or power therefrom. As such, the communication network 480 may be configured to receive one or more PoE conduit or Ethernet cable providing data/signals and power to the user interface 470.

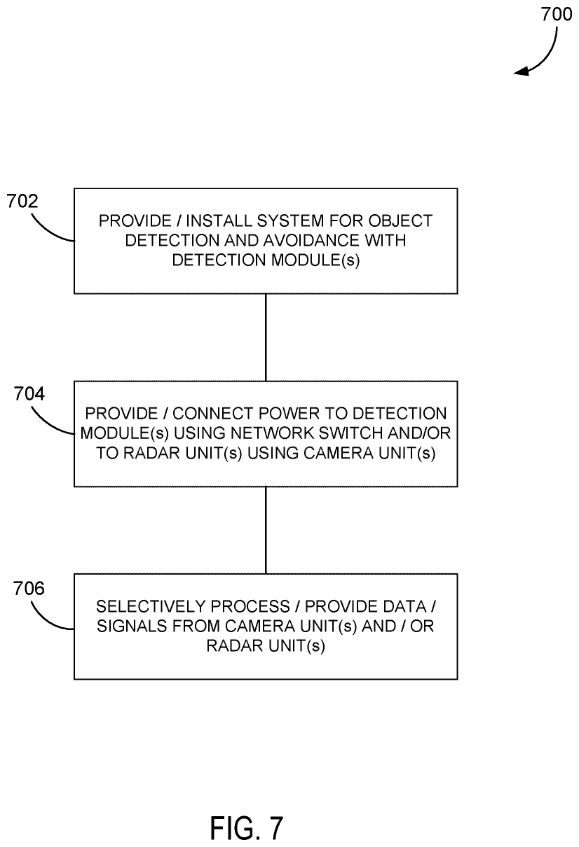

Turning to FIG. 7, a flowchart setting forth steps of a process 700, according to aspects of the present disclosure, is illustrated. Steps of the process 700 may be carried out using any combination of suitable devices or systems, such as systems and devices described in the present disclosure. In some embodiments, steps of the process 700 may be implemented as instructions stored in non-transitory computer-readable media, as a program, firmware or software, and executed by a general-purpose, programmed or programmable computer, processor or other computing device. In other embodiments, steps of the process 700 may be hardwired in an application-specific computer, processor, dedicated system, or module, as described with reference to FIG. 4. Although the process 700 is illustrated and described as a sequence of steps, it is contemplated that the steps may be performed in any order or combination, need not include all illustrated steps, and may include additional steps.

The process 700 may begin at process block 702 with providing or installing a vehicle system for object detection and avoidance on a vehicle. The vehicle system may include various components and hardware, including one or more detection module, each with a camera unit and radar unit in communication with the camera unit. For instance, the vehicle system provided or installed at process block 702 may include a system as described with reference to FIGS. 1-4.

As indicated by process block 704, in some implementations, one or more detection module and/or unit therein may be provided power, for instance, using a network switch. Further, in some implementations, one or more detection module and/or unit therein may provide signals and data, for instance, to a network switch. As such, the detection module(s) and/or unit(s) therein may be connected, for instance, to the network switch, and/or other source of power and/or signals/data. As described, power and signal/data may be provided through a communication link, such as a PoE conduit or Ethernet cable. As such, one or more communication link may be connected to the detection module(s) and/or unit(s) therein, at process block 704.

In some implementations, a unit in a detection module may provide or transfer power to another unit in the detection module. For example, a camera unit may provide or transfer power to a radar unit, or vice versa. Further, in some implementations, a unit in a detection module may communicate or transfer signals and data to another unit in the detection module. For example, a camera unit may communicate or transfer signals and data to a radar unit, or vice versa. In some implementations, power and/or signals/data communication or transfer may be directly provided, for instance, facilitated using one or more direct connection. As such, a camera unit may be electrically connected to a radar unit, for example. In other implementations, power and/or signals/data communication transfer may be indirectly provided, for instance, facilitated by a communication platform integrated in a support structure supporting the detection module. As such, a camera unit and the radar unit may be attached to the support structure. The camera unit may be electrically connected to a radar unit, for example, using a circuit board on the communication platform. In some implementations, data and/or signals may be communicated or transferred between the camera unit and the radar unit using a CAN bus network, a serial communication network, or both, on the communication platform.

Data and/or signals from the camera unit, the radar unit, or both, may be selectively processed and/or provided, as indicated by process block 706. For instance, in some implementations, data and/or signals may be analyzed and/or processed using various algorithms (e.g., computer vision algorithms) to detect one or more objects using imaging data and/or radar data. Responsive to analysis and/or processing of received signals and data, the various raw and/or processed signals, data, and information may be provided a user, for example, in the form of a report.

The report may be in any form and include any signals, data, and information. In some implementations, the report may be provided to a user via a user interface. In other implementations, the report may be stored locally in a memory, or in another storage location. In yet other implementations, the report may be transmitted to a remote location, remote or cloud device (e.g., computer, mainframe, server, database, etc.), and so forth. The report may be provided intermittently and/or continuously. In some implementations, the report may be provided based on a trigger event. For instance, detection of one or more object in proximity to or on a collision path with the vehicle, or another trigger event, may trigger generation, display and/or transmission of the report to a user interface, remote device or cloud device.

In some implementations, data and/or signals from the camera unit, the radar unit, or both, may be selectively processed and/or provided at process block 706 based on vehicle operational data received from a vehicle. As described, operational data may be received from a vehicle communication network, such as a controller area network (CAN) bus network. Hence, in some implementations, data, such as CAN data, received from a vehicle may be converted to a data type compatible with an Ethernet communication protocol. Converted data may then be utilized, for example, by a user interface to selectively process and/or provide data and/or signals various detection modules and/or units therein.

One or more elements or aspects or steps, or any portion(s) thereof, from one or more of any of claims below can be combined with one or more elements or aspects or steps, or any portion(s) thereof, from one or more of any of the other claims, or combinations thereof, to form one or more additional implementations and/or claims of the present disclosure.

While various examples have been described above, these have been presented by way of example, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any application.

The terminology used herein is for the purpose of describing specific examples only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A vehicle system for object detection and avoidance, the vehicle system comprising:
at least one detection assembly, attached or attachable to a vehicle, comprising a camera unit and a radar unit in communication with the camera unit;
a network switch connected or connectable to the at least one detection module using at least one communication link, the network switch configured to transfer power and data to the at least one detection module using the at least one communication link; and
a user interface connected or connectable to the network switch using the at least one communication link,
wherein the camera unit is configured to receive and provide power to the radar unit.

2. The vehicle system of claim 1, wherein the at least one detection assembly comprises a support structure to which the camera unit and the radar unit are attached or attachable.

3. The vehicle system of claim 2, wherein the at least one detection assembly further comprises a communication platform providing communication between the camera unit and the radar unit.

4. The vehicle system of claim 3, wherein the communication platform is integrated in the support structure.

5. The vehicle system of claim 3, wherein the communication platform further comprises a circuit board electrically connecting the camera unit and the radar unit.

6. The vehicle system of claim 3, wherein the communication platform further comprises a controller area network (CAN) bus network, a serial communication network, or both, providing data transmission between the camera unit and the radar unit.

7. The vehicle system of claim 1, wherein the system further comprises at least one enclosure attached or attachable to the detection assembly.

8. The vehicle system of claim 1, wherein the system further comprises a converter in communication with the network switch.

9. The vehicle system of claim 8, wherein the converter is further configured to convert CAN data, received through a vehicle cable connected to a vehicle, to a data type compatible with an Ethernet communication protocol.

10. The vehicle system of claim 9, wherein the user interface is further configured to receive vehicle operational data using the vehicle cable.

11. The vehicle system of claim 10, wherein the user interface is further configured to selectively process or provide data and signals from the at least one detection assembly based at least on the vehicle operational data.

12. The vehicle system of claim 10, wherein the network switch further comprises a Power over Ethernet (PoE) network switch.

13. The vehicle system of claim 1, wherein the at least one communication link further comprises at least one Power Over Ethernet (PoE) conduit or Ethernet cable.

14. A method for object detection and avoidance, the method comprising:
providing or installing a vehicle system for object detection and avoidance on a vehicle, the vehicle system comprising at least one detection assembly with a camera unit and a radar unit in communication with the camera unit;
providing power to the at least one detection module using a network switch connected to the at least one detection module, or providing power to the radar unit using the camera unit in the at least one detection assembly, or both; and
selectively processing data from the camera unit, the radar unit, or both, selectively providing data from the camera unit, the radar unit, or both, to a user interface connected or connectable to the network switch, or both.

15. The method of claim 14, wherein the method further comprises attaching the camera unit and the radar unit to support structure.

16. The method of claim 15, the method further comprising powering the radar unit using a communication platform integrated in the support structure that provides communication between the camera unit and the radar unit.

17. The method of claim 16, the method further comprising electrically connecting the camera unit and the radar unit using a circuit board on the communication platform.

18. The method of claim 16, the method further comprising transmitting data between the camera unit and the radar unit using a CAN bus network, or a serial communication network, or both, on the communication platform.

19. The method of claim 16, the method further comprising selectively processing or providing data and signals from the at least one detection assembly based at least on vehicle operational data received from a vehicle.

20. The method of claim 16, the method further comprising using a converter to convert CAN data received from a vehicle to a data type compatible with an Ethernet communication protocol.
